(19) United States
(12) Patent Application Publication
(10) Pub. No.: US 2026/0105128 A1
(43) Pub. Date: Apr. 16, 2026

(54) DATA GENERATION METHOD, TEXT GENERATION METHOD, AND ELECTRONIC DEVICE

(71) Applicant: Lenovo (Beijing) Limited, Beijing (CN)

(72) Inventors: Yuyang WANG, Beijing (CN); Anna TANG, Beijing (CN)

(21) Appl. No.: 19/356,279

(22) Filed: Oct. 13, 2025

(30) Foreign Application Priority Data
Oct. 14, 2024 (CN) 202411435822.2

(51) Int. Cl. G06F 21/16

(52) U.S. Cl. CPC G06F 21/16

(57) ABSTRACT

A data generation method includes: in response to a target trigger event, obtaining target watermark information; generating target data based on the target watermark information and target input content, such that the target watermark information is embedded in the target data, where the target watermark information is used to identify a source of the target data, and different trigger events correspond to different embedded watermark information embedded in the target data.

### CROSS-REFERENCE TO RELATED APPLICATION(S)

This application claims priority to Chinese Patent Application No. 202411435822.2 filed on Oct. 14, 2024, which is incorporated herein by reference in its entirety.

### FIELD OF THE TECHNOLOGY

The present disclosure relates to a field of computer technology, and in particular to a data generation method, a text generation method, and an electronic device.

### BACKGROUND

With the continuous advancement of computer technology, many data generation tools are now available. These tools may generate data according to user requests. However, although the process of data generation has become increasingly convenient, how to effectively track and determine a particular source of the data generated by the data generation tools remains a problem that needs to be resolved.

### SUMMARY

In one aspect, the present disclosure provides a data generation method. The method includes: in response to a target trigger event, obtaining target watermark information; generating target data based on the target watermark information and target input content, such that the target watermark information is directly or indirectly embedded in the target data, where the target watermark information is used to identify a source of the target data, and different trigger events correspond to different embedded watermark information embedded in the target data.

In another aspect, the present disclosure provides an electronic device. The device includes: a memory storing computer program instructions; and a processor coupled to the memory and configured to execute the computer program instructions and perform: in response to a target trigger event, obtaining target watermark information; generating target data based on the target watermark information and target input content by using an AI (artificial intelligence) processing model for data generation, such that the target watermark information is directly or indirectly embedded in the target data, where the target watermark information is used to identify a source of the target data, and different trigger events correspond to different embedded watermark information embedded in the target data.

In yet another aspect, the present disclosure provides a non-transitory computer-readable storage medium storing computer program instructions executable by at least one processor to perform: in response to a target trigger event, obtaining target watermark information; generating target data based on the target watermark information and target input content, such that the target watermark information is directly or indirectly embedded in the target data, where the target watermark information is used to identify a source of the target data, and different trigger events correspond to different embedded watermark information embedded in the target data.

### BRIEF DESCRIPTION OF THE DRAWINGS

The above and other features, advantages, and aspects of the various embodiments of the present disclosure become more apparent with reference to the following detailed description in conjunction with the accompanying drawings. Throughout the drawings, the same or similar reference numerals represent the same or similar elements. The drawings are schematic and that the originals and elements are not necessarily drawn to scale.

FIG. 1 is a schematic flow chart of a data generation method provided in Example 1 according to certain embodiments of the present disclosure;

FIG. 2 is a schematic diagram of an implementation scenario of a data generation method provided according to certain embodiments of the present disclosure;

FIG. 3 is a schematic diagram of an implementation scenario of a data generation method provided according to certain embodiments of the present disclosure;

FIG. 4 is a schematic diagram of an implementation scenario of a data generation method provided according to certain embodiments of the present disclosure;

FIG. 5 is a schematic diagram of an implementation scenario of the data generation method provided according to certain embodiments of the present disclosure;

FIG. 6 is a schematic diagram of an implementation scenario of a data generation method provided according to certain embodiments of the present disclosure;

FIG. 7 is a schematic diagram of a flow chart of a data generation method provided by Example 7 according to certain embodiments of the present disclosure;

FIG. 8 is a schematic diagram of a flow chart of a data generation method provided by Example 8 according to certain embodiments of the present disclosure;

FIG. 9 is a schematic diagram of a flow chart of a data generation method provided by Example 9 according to certain embodiments of the present disclosure;

FIG. 10 is a schematic diagram of a flow chart of a text generation method provided by Example 10 according to certain embodiments of the present disclosure; and

FIG. 11 is a schematic diagram of structure of a data generation device provided according to certain embodiments of the present disclosure.

### DETAILED DESCRIPTION

The following describes certain embodiments of the present disclosure with reference to the accompanying drawings. The terms used in the implementation section of the present disclosure are intended solely to explain certain embodiments of the present disclosure and are not intended to limit the present disclosure.

The following describes certain embodiments of the present disclosure with reference to the accompanying drawings. Persons skilled in the technical field appreciate that, with technological advancements and the emergence of new scenarios, the technical solutions provided in certain embodiments of the present disclosure are applicable to similar technical problems.

The terms “first”, “second”, or the like, as applicable in the description and claims of the present disclosure and the above-mentioned drawings are used to distinguish similar objects, and are not necessarily used to describe a particular order or sequential order. The terms used in this way may be interchangeable under appropriate circumstances, and this is merely a way of distinguishing the objects of the same attributes when describing them in certain embodiments of the present disclosure. In addition, the terms “including” and “comprising” and any of their variations are intended to cover non-exclusive inclusions, so that the process, method, system, product or device comprising a series of units need not be limited to those units, but may include other units that are not explicitly listed or inherent to these processes, methods, products or device.

With the rapid advancement of natural language processing (NLP) and text generation, target generation models have become core tools in scenarios such as text generation, automated writing, and dialogue systems. These models may generate high quality, coherent text, improving the efficiency and diversity of text creation. However, text generated by target generation models faces certain challenges in copyright protection, model traceability, and user and time tracking.

Although target generation models have achieved results in text creation, it may remain challenging to accurately identify a particular target generation model that generated the text, or to track a particular time of text generation and associated user information. This situation poses a challenge to copyright protection, as once the generated text is misused or infringes upon copyright, it may be difficult to determine the identity of the model, the time of text generation, and associated user information, making it difficult to hold those responsible accountable.

While certain existing watermarking technologies offer some solutions to this problem, they also have limitations.

Static watermarking is a common approach, embedding fixed identifiers (such as model names or copyright notices) into text after it is generated to achieve copyright protection. While static watermarks are relatively simple to embed, their lack of dynamic changes prevents tracking particular user and time information, hence offering limited traceability. Furthermore, static watermarks are easily detected and removed, reducing their effectiveness in practical implementations.

Another watermarking method is visual watermarking and metadata watermarking. Visual watermarking usually places the watermark information in a prominent position in the text, while metadata watermarking uses the text's metadata to carry the watermark information. Although these two methods have the advantage of direct visibility or detection, they face challenges in terms of concealment. Visual watermarks affect the appearance and reading experience of the text, while metadata may be easily tampered with or removed, thus losing the protective effect of the watermark. Therefore, the present disclosure in certain embodiments provides a data generation method to improve the copyright protection and traceability capabilities of model generated data.

The present disclosure is provided below in conjunction with the accompanying drawings.

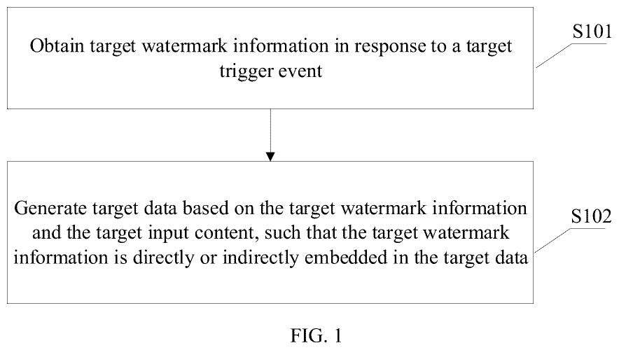

Referring to FIG. 1, there is a flowchart illustrating a data generation method provided in Example 1 of the present disclosure. The data generation method may be implemented by using an Artificial Intelligence (“AI”) processing model or AI generation model for data generation. Such AI processing models may include a natural language processing model that is trained on a massive amount of text to generate human-like text from a prompt as well as other AI processing models. This method may be applied to electronic devices, and the present disclosure does not limit the type of electronic device. As shown in FIG. 1, the method may include, but is not limited to, one of more of:

S101: Obtain target watermark information in response to a target trigger event.

In certain embodiments, the target watermark information obtained in response to different target trigger events may be different. For example, in a multi-functional content creation application, when a user selects the text generation function, a target trigger event is generated, and string data (an implementation of the target watermark information) may be obtained.

In the above-mentioned multi-functional content creation application, when the user selects the image generation function, a target trigger event is generated, and string data (an implementation of the target watermark information) may be obtained; or string data and image elements (an implementation of the target watermark information) may be obtained.

In the multi-functional content creation application described above, when a user selects the audio generation function, a target trigger event is generated, and audio data (an implementation of the target watermark information) is obtained.

The string data obtained in the image generation function and the text generation function may be different.

S102: Generate target data based on the target watermark information and the target input content, such that the target watermark information is directly or indirectly embedded in the target data.

The target input content may be used to guide the target data generation process. The target input content may be at least one of text input content, image input content, and voice input content. Accordingly, the target data may include, but is not limited to, at least one of text data, image elements, video data, and audio data.

For example, in a text processing scenario (text to text scenario), the target input content may be at least one of text input content and image input content, which is used to guide the generation process of text data; in an image processing scenario (text to image scenario or image to image scenario), the target input content may be at least one of image input content and text input content, which is used to guide the generation process of image elements; in an audio processing scenario, the target input content may be voice input content, which is used to guide the generation process of audio data.

In certain embodiments, the target watermark information is directly embedded in the target data. This means the target data contains the target watermark information, but it exists in a non-directly readable or non-directly visible form. For example, the target watermark information may include: “Connect Think Have All” (word for word direction translation from Chinese for expression ‘Lenovo All Rights Reserved’), and the target data may include the following text: “In today's digital age, the Internet (network connect) has permeated every aspect of our lives. Whether it's work, study, entertainment, or socializing, online connections play an indispensable role. . . . Furthermore, through the Internet, we think we want to meet more people, expand our social circles, and communicate, learn, and improve with like-minded friends. . . . These issues prompt us all to think how to better utilize the Internet to maintain and develop healthy interpersonal relationships.” In short, while the Internet connections have helped us expand our interpersonal relationships, it also brings challenges. We need to take advantage of its convenience while paying attention to and maintaining interpersonal relationships in real life. “Connect,” “Think,” “All,” and “Have” are included in the target data, but are distributed in different locations within the target data. For example, in the target watermark information, “Connect” is located in “network connect,” “Think” is located in “we think we want to,” “All” is located in “us all to think,” and “Have” is located in “have helped.”

In certain embodiments, the target watermark information is indirectly embedded in the target data, that is, the target data does not directly contain the original form of the target watermark information, but the target data may contain deformed data of the target watermark information, or the target data and the target watermark information have an implicit association relationship.

The target watermark information may be used to identify the source of the target data. When tracing the target data, the target watermark information may be parsed to trace the target data's generation information, such as the generation model, generation time, and user information.

The target watermark information obtained in response to different target trigger events may be different, allowing for flexible embedding of target watermark information, enabling different watermark information to be embedded in the target data corresponding to different trigger events.

In certain embodiments, target watermark information is obtained in response to a target trigger event. Target data is generated based on the target watermark information and target input content, so that the target watermark information is directly or indirectly embedded in the target data. This helps ensure the concealment of the target watermark information and reduces the risk of malicious detection or removal.

Furthermore, by obtaining different target watermark information in response to different target trigger events, the system may flexibly adapt to various implementation scenarios and needs. The embedding of target watermark information is no longer limited to a fixed pattern or content, but may be adjusted and optimized based on project implementations.

In certain embodiments of the present disclosure, a data generation method is provided in Example 2 of the present disclosure. Certain embodiments provide an implementation method for generating the target trigger event in Example 1. The target trigger event may be, but is not limited to, generated by one or more of:

S11: In response to monitoring first input content input into a first application, generate the target trigger event.

The first application may have an input box or input button (for example, a microphone control) for receiving the first input content.

Accordingly, the first application, or the first application calling the intent recognition model or other sub model within the target generation model, may parse the first input content (an implementation of the target input content), identify the intent from the first input content, and then call the target generation model or a processing sub model within the target generation model to generate target data.

For example, the first application may include, but is not limited to, any of:

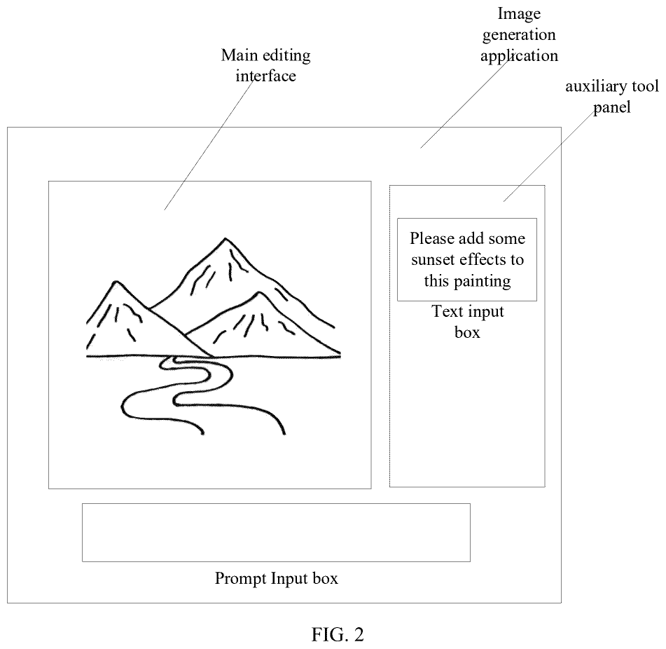

Image generation applications (such as Lenovo's Creator Zone): They are primarily used for generating or processing images. Image generation applications have a main editing interface that displays the image currently being edited or created. Image generation applications may also include an auxiliary tool panel, which may contain a text input box. Users may enter text descriptions or select images for editing in the input box, and the image generation application may generate or modify images based on these inputs. For example, as shown in FIG. 2, when a first input is detected in the text input box in the image generation application, such as “Please add some sunset effects to this painting,” a target trigger event may be generated. This text input box is different from the functional area dedicated to call the AI generation model (such as the prompt input box).

Text generation applications: used to generate text content, such as articles and reports. Users may enter a keyword, topic, or sentence into the text input box, and the text generation application generates the corresponding text content based on the first input. This text input box is different from the functional area dedicated to call the AI generation models.

Video generation applications: These are used to generate or edit video content. Users may enter video descriptions, select video clips, add special effects, in the input box. The video generation applications may generate or modify video content. This input box is different from the functional area dedicated to calling AI generation models.

Intelligent agent applications: These applications, such as Lenovo Xiaotian or AI NOW, integrate multiple functions, including but not limited to text generation, image processing, and speech recognition. Users may generate or process data by interacting with these agents.

Other applications that may call the above applications include conference applications, social media applications (such as WeChat), and photo album applications. Although these applications may not have the ability to generate or process data themselves, they may achieve the effects of model processing services by calling the APIs or plug ins of the above-mentioned image generation applications and intelligent agent applications. For example, in a conference application, users may generate images of meeting minutes by calling the API of the image generation application; in a social media application, users may generate interesting text or image content by calling the plug in of the intelligent agent application.

S12: generate the target trigger event in response to obtaining a second input content, where the second input content is used to call the target generation model of the electronic device;

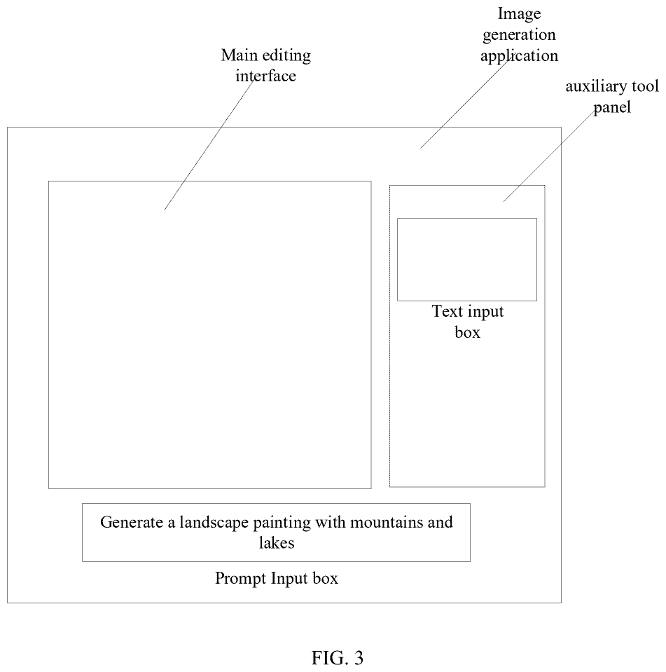

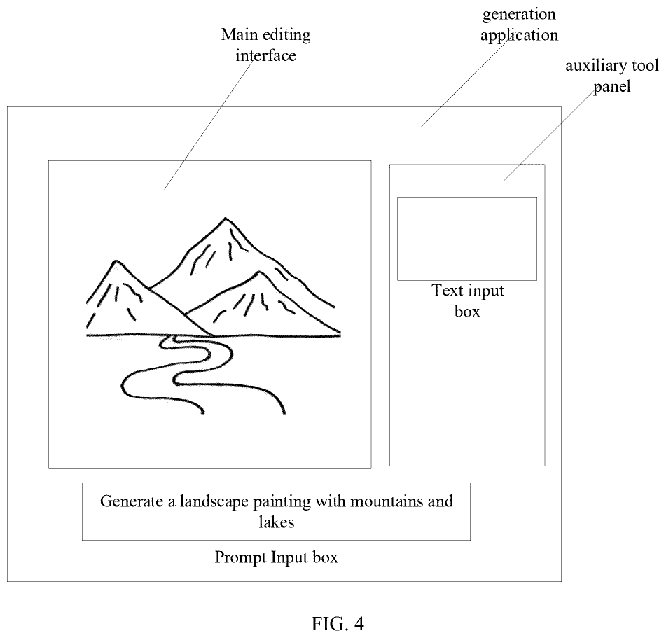

The first application may have a functional area dedicated to call the AI generation model. The functional area may include one or more prompt input boxes for receiving second input content, which may be used to directly call the target generation model of the electronic device. For example, in addition to the auxiliary tool panel, the image generation application may also include a prompt input box. As shown in FIG. 3, you may enter “Generate a landscape painting with mountains and lakes” in the prompt input box of the image generation application. Accordingly, the image generation application may directly call the target generation model to generate a landscape painting with mountains and lakes, as shown in FIG. 4.

In certain embodiments, in addition to entering the second input content in the prompt input box, the second input content may also come from the task location (for example, the location where a particular task is performed in the first application). For example, in the task location, there are several preset options, such as “Mountain Scenery,” “Beach Sunset,” “City Night View,” or the like. When the “Mountain Scenery” option is clicked, the click behavior may be recognized as the second input content, and the second input content may be used to call the AI generation model to generate an image of mountain scenery.

Accordingly, after receiving the second input content (an implementation of the target input content), the first application may directly call the target generation model to generate target data.

S13: In response to receiving the third input content, generate the target trigger event. The third input content may trigger the electronic device to perform operation of embedding the watermark.

In certain embodiments, the third input content may be used to trigger the addition of watermark information when the designated content is sent, allowing users to proactively embed watermark information based on their projects. For example, after the image generation application has generated an image (one implementation of the designated content), the user may click the watermark option in the image generation application. This click behavior may be recognized as the third input content.

Accordingly, generating target data based on the target watermark information and the target input content may include: embedding the target watermark information in the designated content to obtain the target data.

The third input may also be used to trigger the addition of watermark information when generating content, allowing users to proactively embed watermark information based on their projects. For example, a user could enter “Generate a landscape painting with mountains and lakes and add a watermark” in the prompt input box of the image generation application. The content entered in the prompt input box is the third input.

Accordingly, generating target data based on the target watermark information and the target input content may include: embedding the target watermark information into the generated target data during the generation operation corresponding to the third input content.

S14: In response to monitoring an operation to share the target file, generate the target trigger event.

In certain embodiments, an intelligent watermark embedding function may be configured in an electronic device. When the electronic device monitors an operation to share a target file (which may be determined based on file naming, content analysis, or a user's previous tagging), a target trigger event may be generated. Accordingly, in response to the target trigger event, the intelligent watermark embedding function may be triggered to obtain target watermark information and embed the target watermark information into the target file (an implementation of the target input content). This allows the electronic device to automatically embed watermark information into the target file being analyzed, improving user convenience while effectively identifying the source of the target file.

For example, when a user completes a market analysis report and sends it to a partner via email, when the user clicks the “Send” button in the email client, the electronic device may monitor the sharing operation, identify the market analysis report as the target file, and generate a target trigger event. Accordingly, in response to the target trigger event, the target watermark information may be obtained and embedded in the market analysis report.

In certain embodiment of the present disclosure, a data generation method is provided in Example 3 of the present disclosure. The method is implemented for obtaining target watermark information in Example 1. Obtaining target watermark information may include, but is not limited to, one or more of:

S21: Obtain source information of a target trigger event, and based on the source information, obtain target watermark information that aligns with the source information.

The source information of the target trigger event may be used to indicate the type of the target trigger event. For example, the source information may distinguish whether the target trigger event is triggered by a text to text operation (text to text), a text to image operation (text to image), an image to image operation (image to image), or a text to video operation (text to video).

In certain embodiments, a watermark library containing multiple watermarks may be pre-established. Each watermark may be associated with a particular type of trigger event.

Once the source information of the target trigger event is obtained, the watermark library may be searched for a watermark that aligns with the source information. Once an aligning watermark is found, it may be identified as the target watermark for use in subsequent data generation or processing.

S22: Obtain user information and/or model information associated with the target trigger event, and generate the target watermark information based on the user information and/or model information.

User information may be used to identify the user, and model information may be used to identify the target generation model used to generate the data.

For example, in an image generation application, users may generate new images in a particular style by uploading their own images and entering some descriptive text. When a user uploads an image and enters some descriptive text, a target trigger event, that is an image generation event, is generated. Accordingly, in response to the image generation event, the user name “Alice” and user ID “220345” are obtained, as well as the name “ArtGAN” and version number “v2.0” of the image generation application's image generation model. Based on the user name “Alice” and user ID “220345”, as well as the name “ArtGAN” and version number “v2.0” of the image generation model of the image generation application, the target watermark information is generated. The target watermark information may include “User: Alice, ID: 12345, image generation model: ArtGAN v2.0”.

S23: Obtain the user intent represented by the target input content, and obtain target watermark information aligning with the target intent based on the target input content.

In certain embodiments, the user intent represented by the target input content may include, but is not limited to, one or more of: the particular data generation scenario (for example, image generation, text generation, video generation, or the like.), user requirements (for example, whether the generated image format is 2D or 3D, the word limit for generated text, the frame rate and clarity requirements for the video, or the like.), and the user's desired end result (for example, document summarization, document expansion, image beautification, video editing, or the like.).

In certain embodiments, a watermark library containing multiple watermarks may be pre-established. Each watermark may be associated with a particular user intent (for example, generation scenario, user needs, desired effect, or the like.).

After obtaining the user intent, the watermark library may be searched for a watermark that aligns with the user intent. Once an aligning watermark is found, it may be reused as the target watermark, improving efficiency and reducing resource consumption.

When no aligning watermark is found in the watermark library, a new watermark may be generated in real time based on the user's intent as the target watermark.

For example, in an intelligent writing assistant, a user enters the text “Artificial intelligence is changing our lives”(for example, one implementation of the target input). Analysis of the user's input determines that the user intends to generate an expanded document based on this text about “the impact of artificial intelligence on life.” Based on this user intent, a watermark related to “document expansion” is selected from the watermark library as the target watermark.

In certain embodiments of the present disclosure, a data generation method is provided in Example 4 of the present disclosure. The method is implemented for generating target watermark information based on user information and/or model information in Example 3. Generating target watermark information based on user information and/or model information may include, but is not limited to, one or more of:

S31: Process the model information of the target generation model into a first string of data and/or a first set of image elements as target watermark information.

The target generation model may be used to generate target data. The model information may be used to identify the target generation model. For example, the model information may include, but is not limited to, the model name, model version number, and model manufacturer.

For example, when the target generation model generates text data, the model information may be processed into a first string of data.

In certain embodiments, when the target generation model generates image data, the model information may be processed into a first set of image elements. For example, a small, unique icon may be generated to represent the target generation model. This icon may be any shape or pattern.

In certain embodiments, when the target generation model generates image data, the model information may be processed into a first string of data and a first set of image elements.

S32: Process the user information associated with the target trigger event into a second string of data and/or a second set of image elements as the target watermark information.

User information may be used to identify the user who triggered the target trigger event (for example, a generated image event or generated text event). User information may include user name, ID, social media handle, IP address, geographic location, and more.

For example, when a target generation model generates text data, the user information associated with the target trigger event may be processed into a second string of data.

In certain embodiments, when the target generation model generates image data, the user information associated with the target trigger event may be processed into a second set of image elements. For example, a small, unique icon may be generated to represent the user information associated with the target trigger event. This icon may be any shape or pattern.

In certain embodiments, when the target generation model generates image data, the user information associated with the target trigger event may be processed into a second string of data and a second set of image elements.

S33: Process the user information and time information associated with the target trigger event into a second string of data and/or a second set of image elements as the target watermark information.

The time information may be used to identify the execution time of a generation task (for example, an image generation event or a text generation event).

For example, when the target generation model generates text data, the user information and time information associated with the target trigger event may be processed into a second string of data.

In certain embodiments, when the target generation model generates image data, the user information and time information associated with the target trigger event may be processed into a second set of image elements. For example, a small, unique first icon may be generated to represent the user information associated with the target trigger event. A second icon may be generated to represent the time information. The second icon may be a non obtrusive clock, sun, or other image element that may represent time information.

In certain embodiments, when the target generation model generates image data, the user information and time information associated with the target trigger event may be processed into second string data and a second set of image elements.

S34: Process the model information of the target generation model into first string data and/or a first set of image elements, process the user information associated with the target trigger event into second string data and/or a second set of image elements, and process the first string data and/or the first set of image elements and the second string data and/or the second set of image elements into target watermark information.

In certain embodiments, the target watermark information may be used to identify the model information of the target generation model and the user information associated with the target trigger event.

For example, in an image generation application, user “Charlie” generates an image using a target generation model named “ArtGAN.” The information “ArtGAN, Charlie” may be converted into a string of data and embedded into the image generated by the target generation model. In certain embodiments, the information “ArtGAN, Charlie” may be converted into a string of data and processed into a set of image elements. The string of data and the set of image elements may then be embedded into the image generated by the target generation model.

S35: Process the model information of the target generation model into a first string data and/or a first image element set, process the user information and time information associated with the target trigger event into a second string data and/or a second image element set, and process the first string data and/or the first image element set, and the second string data and/or the second image element set into target watermark information.

In certain embodiments, when generating watermark information, a certain order may be followed, that is, the first string data and/or the first image element set are placed first, and the second string data and/or the second image element set are placed later, thereby forming a watermark list.

In certain embodiments, when the watermark list is too long, it may interfere with the semantics and readability of text data or cause noticeable visual impact in image data. Therefore, in certain embodiments, the length of the watermark list may be controlled to help ensure that it contains the necessary information while not adversely affecting the target data.

The target watermark information may be used to identify the model information of the target generation model, the user information associated with the target trigger event, and the time information.

For example, in an intelligent writing assistant, a user enters the text “Artificial intelligence is changing our lives” (for example, one implementation of the target input content). The intelligent writing assistant may generate an expanded document about “the impact of artificial intelligence on life” based on the target generation model. The target generation model's model information may be processed into a first set of image elements (for example, a model logo), and the user information and the time when the user entered the text may be processed into a second string of data. The second string of data is updated each time the user enters new text.

The first image element set is equivalent to a fixed set of image elements, and the second string data is equivalent to a dynamic string data embedded in the target data.

In S35, not only is the model information of the target generation model processed into the first string data and/or the first set of image elements, but the user information and time information associated with the target trigger event are also processed into the second string data and/or the second set of image elements. These two sets of data together constitute the target watermark information. Because the target watermark information contains the model information of the target generation model and the user information and time information associated with the target trigger event, it may easily track the model, user, and time of the particular text or image generation based on the target watermark information, facilitating copyright protection, content auditing, and error tracking.

In certain embodiments, the second string data and/or the second image element set are dynamic and change according to the user and time. Therefore, generated target watermark information is unique, making it difficult to predict or copy the target watermark information, thereby greatly improving the security of the target watermark information.

In certain embodiments, after obtaining the source information of the target trigger event, the type of the target trigger event (for example, text to text, text to image, image to image, text to video, or the like) may be determined based on the source information. When the target trigger event is a text generation scene (for example, text to text), the model information, user information, or the like may be processed into a first string of data. When the target trigger event is an image generation scene, the model information, user information, or the like may be processed into a first set of image elements.

After obtaining the user intent represented by the target input content, the data generation scenario (for example, image generation, text generation, or the like) as well as the user's needs and desired results may be determined based on the user intent. When the user intent is to generate text (for example, document summary, document expansion, or the like), the model information and user information may be processed into a first string of data. When the user intent is to generate an image (for example, image beautification, frame images in a video clip, or the like), the model information and user information may be processed into a first set of image elements.

In certain embodiments of the present disclosure, a data generation method is provided in Example 5 of the present disclosure. The method implements S102 in Example 1. S102 may include, but is not limited to, one or more of:

S1021: Identify the initial user intent represented by the target input content, update the initial user intent using the target watermark information or its associated data to obtain the target user intent, and generate target data aligning with the target user intent.

In certain embodiments, the target input content may be understood and analyzed to determine the initial user intent, such as the type of data the user wants to generate (for example, text, image, video), as well as the particular content or format requirements.

The target watermark information or its associated data may then be used to update the initial user intent to form the target user intent.

The associated data of the target watermark information may include but is not limited to one or more of: data that may replace the target watermark information without affecting the data integrity and functionality. It may contain information similar to or related to the target watermark information but in a different format or expression.

Data obtained by encrypting the target watermark information using an encryption algorithm. For example, the model information of the target generation model in the target watermark information is hashed to generate a hash value to help ensure the uniqueness and immutability of the model information. In addition, the user information and time information in the target watermark information are encrypted using a symmetric or asymmetric encryption algorithm to further enhance the security and uniqueness of the target watermark information.

For example, a user enters a text as the target input: “Please generate a promotional poster for Lenovo Group's latest products.” At this point, the identified initial user intent is to generate a promotional poster featuring Lenovo Group's latest products. The target watermark information (such as the model name “AI Poster Generator V1.0” and the user ID “223045”) may then be used to update the initial user intent, forming the target user intent: “Please use AI Poster Generator V1.0 to generate a promotional poster for Lenovo Group's latest products, and include the user ID 220345 in the poster.” During the poster generation process, a small icon or text containing the model name and user ID may be embedded in the corner or bottom of the poster as the target watermark information.

S1022: Input the target watermark information and target input content into a target generation model that aligns with the target trigger event. During the target generation model's execution of the generation operation corresponding to the target input content, at least a portion of the target watermark information or its associated data is embedded into the generated target data.

During the target generation model's execution of the generation operation corresponding to the target input content, embedding at least a portion of the target watermark information or its associated data into the generated target data may include, but is not limited to:

During the process of the target generation model performing the generation operation corresponding to the target input content, the model information of the target generation model in the target watermark information or its associated data is directly embedded into the generated target data, and the user information and time information in the target watermark information or its associated data are indirectly embedded into the generated target data.

During the process of the target generation model executing the generation operation corresponding to the target input content, the model information of the target generation model in the target watermark information or its associated data is directly embedded into the generated target data, which may include but is not limited to: updating the candidate words of the target generation model based on the model information of the target generation model in the target watermark information or its associated data, and based on the candidate words of the updated target generation model, during the process of the target generation model executing the generation operation corresponding to the target input content, embedding the model information into the generated target data.

Updating the candidate words in the target generation model based on the model information of the target generation model in the target watermark information or its associated data may include, but is not limited to, adding the model information of the target generation model in the target watermark information or its associated data, or synonyms, phrases, or particular vocabulary corresponding to the model information, to the candidate words in the target generation model.

Based on the updated candidate words in the target generation model, embedding the model information helps ensure that the semantic coherence of the generated target data is not compromised.

During the target generation model's generation operation corresponding to the target input content, indirectly embedding user information and time information from the target watermark information or its associated data into the generated target data may include:

During the target generation model's generation operation corresponding to the target input content, influencing the target generation model's prediction of the next word selection range based on the user information and time information from the target watermark information or its associated data to generate the target data.

For example, a mapping table may be constructed to record the mapping relationship between user information, time information, and codes. The codes are used to represent the probability distribution of each type of word after classifying the candidate words of the target generation model.

For example, the user information includes a user ID of 220345. For example, the 2 in 220345 corresponds to the code 123, and the 0 in 220345 corresponds to code 234. The target generation model first performs the generation operation corresponding to the target input content according to the code 123. Code 123 means that the probability of the first category of words is the highest, the probability of the second category of words is in the middle, and the probability of the third category of words is the lowest. When generating the first 100 words, when 10 words have been generated, when generating 11 words, the target generation model predicts the probability of each candidate word among the 30,000 candidate words, and then selects 6,000 words belonging to the first category from the 30,000 candidate words. According to the probability of the 6,000 words, one output is extracted as the 11^{th} word. When generating 12 words, the target generation model predicts the probability of each candidate word in 30,000 candidate words, and then selects 6,000 words belonging to the first category from the 30,000 candidate words, and extracts an output as the 12^{th} word based on the probability of 6,000 words; and so on, when generating 14 words, the target generation model predicts the probability of each candidate word in 30,000 candidate words, and then selects 6,000 words belonging to the first category from the 30,000 candidate words, and extracts an output as the 14^{th} word based on the probability of 6,000 words, thereby achieving 4 consecutive times of extracting an output from the first category of words.

Then, when the 15^{th} word is generated, the target generation model predicts the probability of each candidate word among the 30,000 candidate words, and then selects 5,000 words belonging to the second category from the 30,000 candidate words, and extracts an output as the 15^{th} word based on the probability of 5,000 words. Similarly, when the 17^{th} word is generated, the target generation model predicts the probability of each candidate word among the 30,000 candidate words, and then selects 5,000 words belonging to the second category from the 30,000 candidate words, and extracts an output as the 17^{th} word based on the probability of 5,000 words, thereby achieving 3 consecutive times of extracting an output from the words of the second category.

Then, when the 18^{th} word is generated, the target generation model predicts the probability of each candidate word among the 30,000 candidate words, and then selects 8,000 words belonging to the third category from the 30,000 candidate words, and extracts an output as the 18^{th} word based on the probability of the 8,000 words. Similarly, when the 19^{th} word is generated, the target generation model predicts the probability of each candidate word among the 30,000 candidate words, and then selects 8,000 words belonging to the third category from the 30,000 candidate words, and extracts an output as the 19^{th} word based on the probability of the 8,000 words, thus achieving a consecutive extractions of an output from the third category of words.

During the process of the target generation model performing the generation operation corresponding to the target input content, the target generation model may distinguish and insert the model information, user information, and time information. The target generation model may embed the model information into the generated target data corresponding to the target input content at the initial stage of the generation operation corresponding to the target input content. That is, the model information and target data are generated simultaneously, rather than embedding the model information after the target data is generated.

In certain embodiments, the target generation module may embed the user information and time information at a later stage of the generation operation corresponding to the target input content.

For example, a user enters a text message as the target input: “Please generate a promotional poster for Lenovo Group's latest product.” This generates a target trigger event, the generated image event. At this point, the target watermark information is obtained: model name “AI Poster Generator V1.0”, user ID “220345”, and time “10.2”. The target watermark information and the target input content are input into the target generation model that aligns with the generated image event. As the target generation model performs the generation operation corresponding to the target input content, at least a portion of the target watermark information or its associated data is embedded in the generated poster.

S1023: Determine a target location within the initial generated data generated based on the target input content, and insert at least a portion of the target watermark information or its associated data into the corresponding target location to generate the target data.

The target location may be determined by, but is not limited to, one or more of:

S41: A random number generator is used to randomly select a location within the initially generated data as the target location.

This random selection of the location based on the random number generator helps ensure the randomness and unpredictability of the target watermark insertion location, thereby increasing the concealment and security of the target watermark information.

S42: Analyze the target watermark information or its associated data, compare it with the initially generated data, find the parts with the same or relatively high similarity, and replace the parts with the target watermark information to obtain the target data.

S42 maintains the consistency of the target data while effectively concealing the watermark. The replacement does not alter the semantics of the initially generated data or the primary content of the image.

S43: When a particular word or symbol appears in the initially generated data, its location is determined as the insertion point for the target watermark information or its associated data.

At S1023, by determining the target position, it may be ensured that the insertion of the target watermark information should not cause confusion of text semantics or obvious changes in image content, so as to help ensure that the target watermark information may achieve its traceability function without affecting the normal use of the data. For example, the target watermark information may include: “Connect Think Have All” (word for word direction translation from Chinese for expression ‘Lenovo All Rights Reserved’). The initial generated data generated based on the target input content (for example, “generate a text about the impact between the Internet and life”) may include the following text: “In today's digital age, the Internet (network connect) has permeated every aspect of our lives. Whether it's work, study, entertainment, or socializing, online connections play an indispensable role. . . . Furthermore, through the Internet, we may meet more people, expand our social circles, and communicate, learn, and improve with like-minded friends. However, the Internet also has some negative effects. First, . . . sometimes, we may be hurt by trusting others online, leading to a breakdown in trust.

Determine the target position in the initial data generated above, and insert “Connect Think Have All” (word for word direction translation from Chinese for expression ‘Lenovo All Rights Reserved’) into the corresponding target position. The generated target data may include: “the Internet (network connect) has permeated every aspect of our lives. Whether it's work, study, entertainment, or socializing, online connections play an indispensable role. . . . Furthermore, through the Internet, we may meet more people, expand our social circles, and communicate, learn, and improve with like-minded friends. However, the Internet also has some negative effects. First, . . . sometimes, we may be hurt by trusting others online, leading to a breakdown in trust. These issues prompt us all to think how to better utilize the Internet to maintain and develop healthy interpersonal relationships. In short, while the Internet connections have helped us expand our interpersonal relationships, it also brings challenges. We need to take advantage of its convenience while paying attention to and maintaining interpersonal relationships in real life.”

In the target data, “Connect Think Have All” (word for word direction translation from Chinese for expression ‘Lenovo All Rights Reserved’) does not cause semantic confusion or semantic incoherence, and the target watermark information may also achieve traceability.

In certain embodiments, the amount of target watermark information or its associated data to be inserted into the target location may be flexibly determined based on factors such as the type and volume of the initially generated data, and the implementation scenario.

For example, different types of generated data have different requirements for watermark embedding:

Text data: In text data, the target watermark may be inserted at the beginning, end, between paragraphs, or at a particular location, depending on the content and format of the text. Furthermore, factors such as the text's language characteristics and encoding method are considered to help ensure that the insertion of the target watermark does not disrupt the text's syntax and semantics.

Image data: In image data, the target watermark information is usually embedded in the form of image elements. Depending on the image's resolution, color depth, and other characteristics, the target watermark information may be inserted in particular areas of the image (such as corners, edges, or background), or by leveraging image characteristics such as texture and color.

Audio/Video Data: In audio or video data, target watermark information is inserted as subtle changes in the audio signal, pixel changes in the video frame, or particular encoding patterns. Watermark insertion for this type of data may require consideration of factors such as the audio or video compression format, bitrate, and frame rate to help ensure that the watermark does not significantly impact the audio or video quality.

When the initial data volume is large, the target watermark may be inserted in multiple locations to increase the watermark's stealth and robustness.

When the initial data size is small, the insertion location and target watermark amount may require greater care. Excessive watermarking may lead to data corruption or distortion, so a trade off may need to be made based on the situation.

The implementation scenario also plays a role in determining the amount of watermark to be inserted. For example, in copyright protection scenarios, watermark information should be sufficiently concealed and robust to counter possible tampering and attacks. Therefore, the appropriate insertion location and amount should be chosen to help ensure that the watermark effectively delivers the desired information. Alternatively, in data tracking scenarios, watermark information should accurately identify the source and flow of data. Therefore, the appropriate insertion method and amount should be selected based on the data characteristics and implementation scenario to help ensure that the watermark effectively conveys the desired information.

In certain embodiments of the present disclosure, a data generation method is provided in Example 6 of the present disclosure. The method implements a method of directly or indirectly embedding target watermark information into target data in Example 1 or 5. The method of directly or indirectly embedding target watermark information into target data may include but is not limited to one or more of:

S51: Obtain attribute information of the target data. Based on the attribute information, embed the target watermark information or its associated data into the target data using a target embedding strategy. The amount of target watermark information or its associated data embedded into the target data varies under different embedding strategies.

The attribute information of the target data may indicate the type (for example, text, image, audio, video, or the like) and size (for example, the length of text data or the number of image elements in image data) of the target data.

Based on the target data's attribute information, an appropriate target embedding strategy may be selected to embed the target watermark information. For example, in long text data (text data whose length meets a set threshold, or the text data contains multiple paragraphs or sentences, or the like), the target watermark information may be embedded in appropriate locations, such as at the beginning or end of a paragraph, between sentences, or near particular keywords. Choosing the right embedding location may ensure the watermark's stealth and robustness. For example, one or several watermark characters may be inserted at the end of each paragraph or within particular sentences. This way, even when the text is partially copied or modified, the target watermark information is likely to be preserved.

In certain embodiments, to enhance concealment, the target watermark information may be dispersed across multiple locations within the long text data. This may be achieved by gradually inserting the target watermark information into different paragraphs or sentences within the long text data. For example, the target watermark information may be divided into multiple parts, each of the parts is embedded in a different paragraph of the long text data. This way, even when a paragraph is deleted or modified, the watermark information in other paragraphs may still be present.

S52: Obtain usage information for the target data. Based on the usage information, embed the target portion of the target watermark information or its associated data into the target data. The target portion is the portion that aligns with the usage information.

The usage information may be used to characterize the intended use or scenario of the target data. For example, the usage information may indicate whether the target data is intended for personal learning (self use scenario) or for sharing with others (sharing scenario), whether it is intended for summary reporting or content expansion, whether it is intended for presentation in a formal meeting or for sharing on social media, or the like.

Different embedding strategies may be used for different types of target data (such as narrative text, conversational text, or the like) to suit their particular structure and content. For example, when the target data is used for a summary report, the target data type is narrative text. The target watermark information may be embedded in the target data in the form of academic words or phrases to increase the concealment of the watermark information. Furthermore, when the target data is long text, the target watermark information may be dispersed to multiple locations within the long text.

In certain embodiments, when the target data is intended for sharing in conversations on social media, the target watermark information may be embedded into the target data in the form of a conversation, comment, or emoticon to help ensure the watermark's confidentiality.

S53: Obtain authorization information from the target user and, based on the authorization information, determine whether to embed the target watermark information or associated data into the target data.

In certain embodiments, the target user may be the user who triggers the target trigger time or enters the target input content.

The authorization information may indicate whether explicit display of the watermark information is permitted.

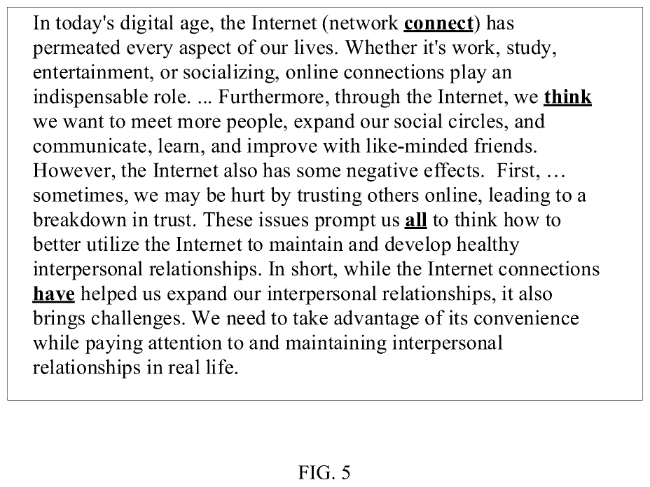

When the target user's authorization information indicates permission for explicit display of the watermark information, the target watermark information may be displayed prominently in the generated target data. For example, when the target watermark information is “Connect Think Have All” (word for word direction translation from Chinese for expression ‘Lenovo All Rights Reserved’), as shown in FIG. 5, the four words “Connect Think Have All” (word for word direction translation from Chinese for expression ‘Lenovo All Rights Reserved’) may be displayed in bold and underlined format to help ensure that the user may easily identify the target watermark information.

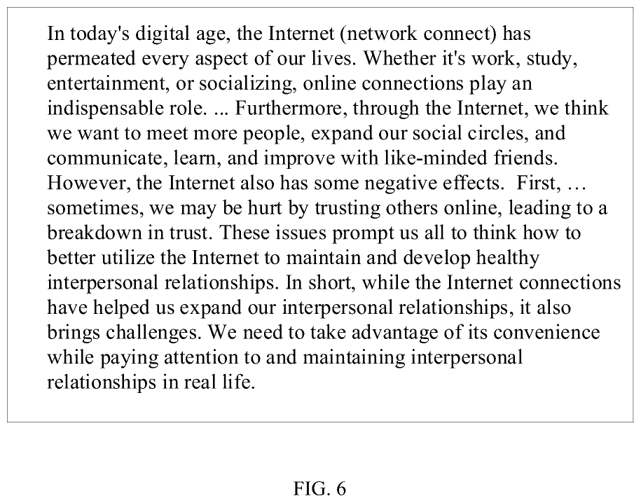

When the target user's authorization information indicates that explicit display of the target watermark information is not permitted, an implicit watermark strategy may be selected by default. That is, the target watermark information is not prominently displayed in the generated target data. For example, when the target watermark information is “Connect Think Have All” (word for word direction translation from Chinese for expression ‘Lenovo All Rights Reserved’), as shown in FIG. 6, the four words “Connect Think Have All” (word for word direction translation from Chinese for expression ‘Lenovo All Rights Reserved’) may be embedded in the same format as other text data, making it impossible for ordinary users to directly identify the target watermark information.

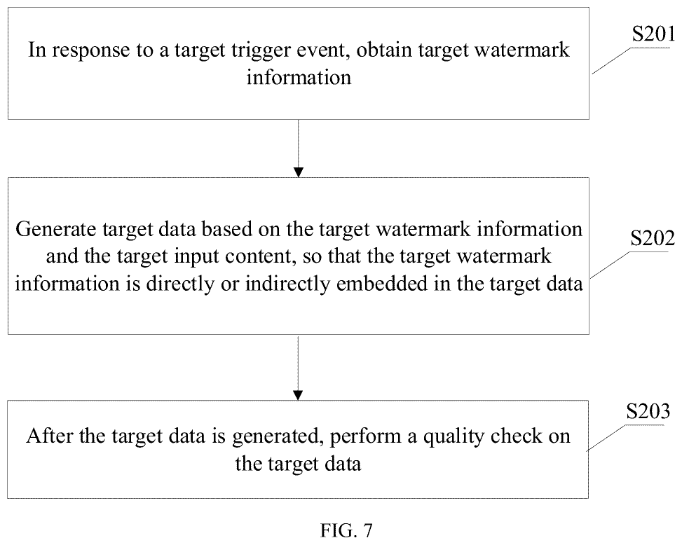

In certain embodiments of the present disclosure, FIG. 7 is a flow chart illustrating a data generation method provided in Example 7 of the present disclosure. As shown in FIG. 7, the method may include, but is not limited to, one or more of:

S201: In response to a target trigger event, obtain target watermark information.

The target watermark information is used to identify the source of the target data. Different trigger events correspond to different watermark information embedded in the target data.

S202: Generate target data based on the target watermark information and the target input content, so that the target watermark information is directly or indirectly embedded in the target data.

The detailed process of steps S201 S202 may be found in the description of steps S101 S102 in Example 1 and the description is not repeated here for brevity.

S203: After the target data is generated, perform a quality check on the target data.

When the result of the quality check indicates that the quality of the target data does not meet the set condition (for example, the semantic coherence and readability of the text data do not meet the coherence and readability set conditions, and the display layout and hierarchical relationship of the image data do not meet the display layout and hierarchical relationship set conditions), the target generation model may be adjusted and the target data may be regenerated based on the adjusted target generation model.

For example, after generating text data, the text data may be tested for semantic coherence and readability to help ensure that the text data after embedding the target watermark information still maintains its original semantic integrity and logical order, and there is no semantic break or ambiguity caused by the watermark embedding. At the same time, the readability of the text data may also need to be confirmed, that is, the text data after embedding the target watermark information may maintain a clear font, appropriate font size and spacing, and an easy to read format.

In certain embodiments, it is also possible to detect whether the text data after embedding the target watermark information still conforms to the user's intent as represented by the target input content. For example, when the user input text (for example, the target input content) expresses a particular point of view or emotion, it is possible to detect whether the text data after embedding the target watermark information has changed the expression of these points of view or emotions.

After the image data is generated, the display layout and hierarchical relationship of the image data may be checked to help ensure that the image data after embedding the target watermark information still maintains the original image structure and layout, and the embedding of the target watermark information does not disrupt the integrity or hierarchy of the image data. At the same time, the location and size of the target watermark information may also be reasonably controlled to help ensure that it does not affect the visual effect of the image data while still serving as its identification function.

In certain embodiments, it is also possible to detect whether the image data after embedding the target watermark information maintains its original image quality and clarity, thereby helping ensure that the embedding of the target watermark information does not cause issues such as blurring, distortion, or color deviation in the image.

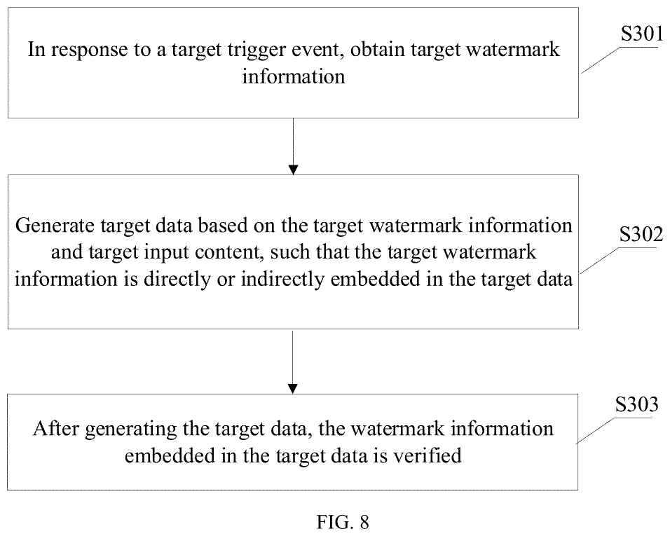

In certain embodiments of the present disclosure, referring to FIG. 8, there is a flow chart of a data generation method provided in Example 8 of the present disclosure. As shown in FIG. 8, the method may include, but is not limited to, one or more of:

S301: In response to a target trigger event, obtain target watermark information.

The target watermark information is used to identify the source of the target data. Different trigger events correspond to different watermark information embedded in the target data.

S302: Generate target data based on the target watermark information and target input content, such that the target watermark information is directly or indirectly embedded in the target data.

The detailed process of steps S301 S302 may be found in the description of steps S101 S102 in Example 1 and the description is not be repeated here for brevity.

S303: After generating the target data, the watermark information embedded in the target data is verified.

In certain embodiments, a watermark list may be constructed based on the target watermark information. This watermark list may include all watermark information that should appear in the target data, as well as their expected order.

The watermark information embedded in the target data is aligned with the watermark list. When the degree of alignment reaches a preset threshold, the target data is determined to contain valid watermark information.

In certain embodiments, a reasonable error tolerance threshold may also be set based on the importance of the target watermark information and the characteristics of the data. This error tolerance threshold may represent the maximum allowable watermark information misalignment ratio.

When aligning the watermark information embedded in the target data with the watermark list, when the misalignment is found to be within the tolerance threshold, the watermark is still considered valid.

The tolerance threshold may also be dynamically adjusted based on the needs of the implementation scenario. For example, in scenarios where data transmission security is a priority, the tolerance threshold may be lowered to increase the stringency of watermark verification. In scenarios where data transmission efficiency is a priority, the tolerance threshold may be appropriately increased, sacrificing some security for improved verification efficiency.

In certain embodiments, to account for potential damage or changes during text transmission (such as character loss, substitution, or insertion), a tolerance threshold may be set to allow verification of the watermark's validity even when a certain percentage of the watermark information is missing or altered.

In certain embodiments, the integrity of the watermark information, as a data identifier, is directly linked to verifying the data's origin and authenticity. By verifying the watermark information in the target data, it is possible to ensure that the target data has not been tampered with or damaged during transmission or processing, thereby maintaining data integrity and credibility.

In certain embodiments, one or more of the following may also be performed after S301 S302:

After generating the target data, perform a quality check on the target data.

The detailed process of performing a quality check on the target data after generating the target data may be found in the description of S203 above and the description is not repeated here for brevity.

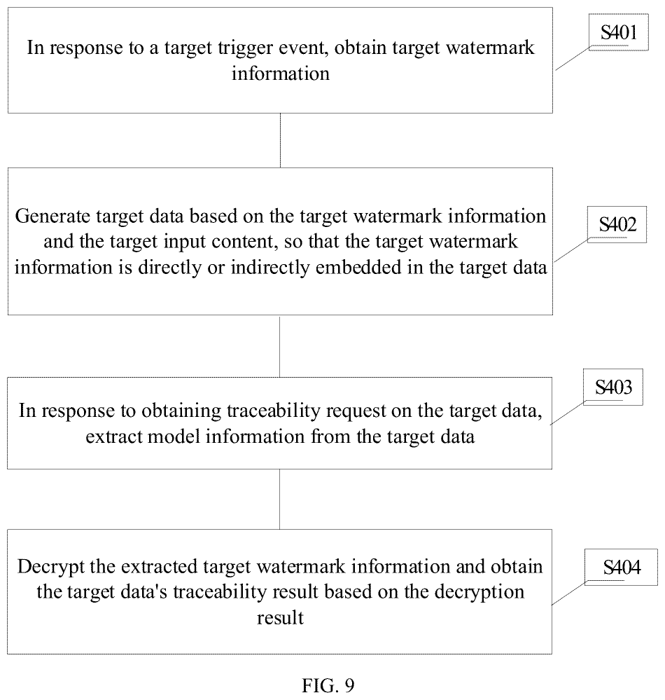

In certain embodiments of the present disclosure, FIG. 9 is a flow chart illustrating a data generation method provided in Example 9 of the present disclosure. As shown in FIG. 9, the method may include, but is not limited to, one or more of:

S401: In response to a target trigger event, obtain target watermark information.

The target watermark information is used to identify the source of the target data. Different trigger events correspond to different watermark information embedded in the target data.

S402: Generate target data based on the target watermark information and the target input content, so that the target watermark information is directly or indirectly embedded in the target data.

The detailed process of steps S401 S402 may be found in the description of steps S101 to S102 in Example 1 and the description is not repeated here for brevity.

S403: In response to receiving a traceability request for the target data, extract the target watermark information from the target data.

When the target watermark information is encrypted and embedded in the target data, the target watermark information extracted from the target data is the encrypted target watermark information.

In certain embodiments, extracting the target watermark information from the target data may include, but is not limited to, one or more of:

S4031: Extract model information from the target data.

S4032: Based on the model information of the target generation model in the target watermark information, a watermark list is constructed. This watermark list may include all model information that should appear in the target data, along with their expected order.

S4033: The extracted model information is aligned with the watermark list. When the alignment reaches a preset threshold, the target data is determined to contain valid model information, and user information and time information are extracted from the target data.

Corresponding to an implementation method of generating target data by influencing the target generation model to predict the next word selection range based on the target watermark information or the user information and time information in its associated data during the target generation model's execution of the generation operation corresponding to the target input content, when extracting user information and time information from the target data, statistics may be performed on various types of words in the target data to obtain statistical result, and the codes that align with the statistical result may be searched in the mapping table to obtain the user information and/or time information corresponding to the codes in the mapping table.

S404: Decrypt the extracted target watermark information and obtain the target data's traceability result based on the decryption result.

In certain embodiments, the extracted model information, user information, and time information may be decrypted to obtain the model information, user information, and time information.

The target data's traceability result may clearly indicate the model name and/or version number that generated the target data, display the name and user ID of the user who generated the target data, and display the time the target data was generated, which may include a date and timestamp.

In certain embodiments, the traceability result may be displayed to users or administrators in a visual or textual format to help them understand the source of the target data.

In certain embodiments, each traceability result may be recorded in the system log for subsequent auditing or analysis.

In certain embodiments, by decrypting the extracted watermark information, the original watermark content may be restored, accurately revealing the source of the target data. This allows the target data to be effectively tracked and located during its circulation, thereby improving the traceability and manageability of the target data.

Furthermore, encryption and decryption technologies help ensure the privacy and security of target data during the data generation and traceability processes, preventing its leakage and misuse.

Furthermore, by extracting user and time information, dual traceability of time and events is achieved, allowing users to determine not only who generated the data but also when it was generated.

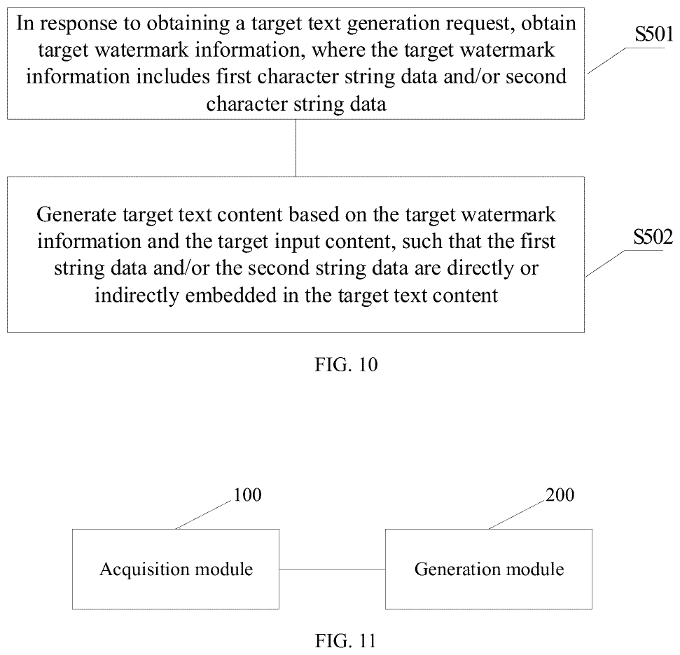

In certain embodiments of the present disclosure, referring to FIG. 10, a flowchart of a text generation method provided in Example 10 of the present disclosure is provided. As shown in FIG. 10, the method may include, but is not limited to, one or more of:

S501: In response to obtaining a target text generation request, obtain target watermark information, where the target watermark information includes first character string data and/or second character string data.

As described in the previous embodiments, model information of the target generation model may be processed into first string data, and at least one of user information and time information associated with the target trigger event may be processed into second string data.

S502: Generate target text content based on the target watermark information and the target input content, such that the first string data and/or the second string data are directly or indirectly embedded in the target text content.

The detailed process of S502 may be found in the aforementioned embodiments regarding generating target data based on the target watermark information and target input content, thereby directly or indirectly embedding the target watermark information into the target data. Such details are not repeated here for brevity.

For example, the target input content may be used to call a text generation model of an electronic device. Accordingly, the target watermark information and target input content may be input into the text generation model. During the text generation model's execution of the generation operation corresponding to the target input content, at least a portion of the target watermark information or its associated data may be embedded into the generated target text content.

The target watermark information is used to identify the source of the target text. Different watermark information is embedded in the target text content corresponding to different text generation requests.

In certain embodiments, embedding is controlled by the target input content, allowing the first character string data and/or the second character string data to be directly or indirectly embedded in the target text content. This helps ensure that the target watermark information is difficult to detect or remove without affecting the natural flow of the target text content.

By directly or indirectly embedding the first and/or second string data into the target text content, not only may the text generation model be identified, but the particular user and time of text generation may also be tracked, providing strong traceability.

Furthermore, the second string data is dynamic, changeable based on user and time. Therefore, each generated target watermark is unique, making it difficult to predict or replicate, thereby significantly enhancing its security.

Next, a data generation device provided by certain embodiments of the present disclosure is introduced. The data generation device described below may be referenced in conjunction with the data generation method described above.

Referring to FIG. 11, the data generation device includes an acquisition module 100 and a generation module 200.

Acquisition module 100 is configured to obtain target watermark information in response to a target trigger event.

The generation module 200 is configured to generate target data based on the target watermark information and target input content, such that the target watermark information is directly or indirectly embedded in the target data.

The target watermark information is used to identify the source of the target data, and the watermark information embedded in the target data corresponding to different trigger events is different.

The target trigger event may be generated by one or more of:

In response to monitoring a first input content input into a first application, generating the target trigger event;

In response to obtaining a second input content, generating the target trigger event, the second input content being used to call a target generation model of the electronic device;

In response to obtaining a third input content, generating the target trigger event, the third input content being capable of triggering the electronic device to perform an operation of adding watermark information;

In response to monitoring an operation of sharing a target file, the target trigger event is generated.

The acquisition module 100 obtains target watermark information, which may include one or more of:

Obtaining source information of the target trigger event, and obtaining target watermark information aligning with the target trigger event based on the source information;

Obtaining user information and/or model information associated with the target trigger event, and generating the target watermark information based on the user information and/or model information;

Obtaining the user intent represented by the target input content and obtaining target watermark information that aligns with the user intent based on the user intent.

Acquisition module 100 generates the target watermark information based on the user information and/or model information, and may include one or more of:

Processing model information of the target generation model into a first string of data and/or a first set of image elements as the target watermark information;

Processing user information associated with the target trigger event into a second string of data and/or a second set of image elements as the target watermark information;

Processing the user information and time information associated with the target trigger event into a second string data and/or a second set of image elements as the target watermark information;

Processing the model information of the target generation model into a first string data and/or a first set of image elements, processing the user information associated with the target trigger event into a second string data and/or a second set of image elements, and processing the first string data and/or the first set of image elements and the second string data and/or the second set of image elements into the target watermark information;

The model information of the target generation model is processed into a first string data and/or a first image element set, the user information and time information associated with the target trigger event are processed into a second string data and/or a second image element set, and the first string data and/or the first image element set, as well as the second string data and/or the second image element set, are processed into target watermark information.

The generation module 200 generates target data based on the target watermark information and the target input content, and may include one or more of:

Identifying the initial user intent represented by the target input content, updating the initial user intent using the target watermark information or its associated data to obtain a target user intent, and generating target data that aligns with the target user intent;

The target watermark information and target input content are input into a target generation model that aligns with the target trigger event. During the target generation model's execution of a generation operation corresponding to the target input content, at least a portion of the target watermark information or its associated data is embedded into the generated target data.

A target position is determined in the initial generated data generated based on the target input content, and at least a portion of the target watermark information or its associated data is inserted into the corresponding target position to generate the target data.

In certain embodiments, the generation module 200 embeds the target watermark information directly or indirectly into the target data, which may include one or more of:

Obtaining attribute information of the target data, and embedding the target watermark information or its associated data into the target data using a target embedding strategy based on the attribute information, where the amount of target watermark information or its associated data embedded into the target data varies under different embedding strategies;

Obtaining usage information for the target data and, based on the usage information, embedding a target portion of the target watermark information or its associated data into the target data, where the target portion is the portion that aligns with the usage information;

Obtaining authorization information for the target user and based on the authorization information, determining to embed the target watermark information or its associated data into the target data.

The data generation device may include one or more of:

A detection module is configured to perform quality check on the target data after the target data is generated.

A verification module is configured to verify the watermark information embedded in the target data after the target data is generated.

The data generation device may include one or more of:

An extraction module is configured to extract target watermark information from the target data in response to a traceability request for the target data.

A traceability module is configured to decrypt the extracted target watermark information and obtain a traceability result for the target data based on the decryption result.

In certain embodiments of the present disclosure, a text generation device is provided. The text generation device and the text generation method described above may correspond to each other.

The text generation device may include:

An acquisition module configured to obtain target watermark information in response to a target text generation request, where the target watermark information includes first character string data and/or second character string data;

A generation module is configured to generate target text content based on the target watermark information and target input content, such that the first character string data and/or the second character string data are directly or indirectly embedded in the target text content.

The target watermark information is used to identify the source of the target text, and different watermark information embedded in the target text content correspond to different text generation requests.

In certain embodiments of the present disclosure, an electronic device is provided.

The electronic device may include:

a memory for storing a computer program;

a processor for executing the computer program, so that the electronic device may implement the data generation method described in any one of Examples 1 to 9 or the text generation method described in Example 10.

A computer readable storage medium is also provided in certain embodiments of the present disclosure. The storage medium carries one or more computer programs. When the one or more computer programs are executed by an electronic device, the electronic device may implement the data generation method described in any one of Examples 1 to 9 or the text generation method described in Example 10.

The device embodiments described above are merely illustrative, where the units described as separate components may or may not be physically separate, and the components displayed as units may or may not be physical units, that is, they may be located in one place, or they may be distributed across multiple network units. Some or all of the modules may be selected according to projects at hand to achieve the purpose of certain embodiments. In addition, in the drawings of the device embodiments provided in the present disclosure, the connection relationship between the modules indicates that there is a communication connection between them, which may be implemented as one or more communication buses or signal lines.

Through the above description of the embodiments, those skilled in the technical field understand that the present disclosure may be implemented by software plus necessary general purpose hardware, and may also be implemented by dedicated hardware including application specific integrated circuits, dedicated CPUs, dedicated memories, dedicated components, or the like. In general, any function performed by a computer program may be easily implemented by the corresponding hardware. Moreover, the hardware structures used to implement the same function may also be diverse, such as analog circuits, digital circuits, or dedicated circuits. However, for certain embodiments of the present disclosure, software program implementation is a implementation method. The technical solution of the present disclosure may be embodied in the form of a software product. This computer software product is stored in a readable storage medium, such as a computer floppy disk, USB flash drive, mobile hard disk, ROM, RAM, magnetic disk or optical disk, or the like, and includes a number of instructions for enabling a computer device (which may be a personal computer, training equipment, or network equipment, or the like) to execute the methods described in certain embodiments of the present disclosure.

In the above embodiments, all or part of the embodiments may be implemented by software, hardware, firmware, or any combination thereof. When implemented by software, all or part of the embodiments may be implemented in the form of a computer program product.

The computer program product includes one or more computer instructions. When the computer program instructions are loaded and executed on a computer, the process or function described in certain embodiments of the present disclosure is generated in whole or in part. The computer may be a general purpose computer, a special purpose computer, a computer network, or other programmable device. The computer instructions may be stored in a computer readable storage medium or transferred from one computer readable storage medium to another computer readable storage medium, for example, the computer instructions may be transmitted from one website, computer, training device or data center to another website, computer, training device or data center via wired (for example, coaxial cable, optical fiber, digital subscriber line (DSL)) or wireless (for example, infrared, wireless, microwave, or the like) connections. The computer readable storage medium may be any available medium that may be stored by a computer or a data storage device such as a training device, data center, or the like that includes one or more available media. The available medium may be a magnetic medium (for example, a floppy disk, a hard disk, a tape), an optical medium (for example, a DVD), or a semiconductor medium (for example, a solid state disk (SSD)).

What is claimed is:

1. A data generation method, comprising:
in response to a target trigger event, obtaining target watermark information;
generating target data based on the target watermark information and target input content, such that the target watermark information is embedded in the target data, wherein
the target watermark information is used to identify a source of the target data, and different trigger events correspond to different embedded watermark information embedded in the target data.

2. The method of claim 1, wherein the target trigger event is generated by one or more of:
the target trigger event is generated in response to monitoring a first input content inputted into a first application;
the target trigger event is generated in response to obtaining a second input content, the second input content being used to call a target generation model of an electronic device;
the target trigger event is generated in response to obtaining a third input content, the third input content being capable of triggering the electronic device to perform an operation of adding watermark information; and
the target trigger event is generated in response to monitoring an operation of sharing a target file.

3. The method of claim 1, wherein obtaining target watermark information includes one or more of:
obtaining source information of the target trigger event, and obtaining target watermark information aligning with the target trigger event based on the source information;
obtaining user information and/or model information associated with the target trigger event, and generating the target watermark information based on the user information and/or model information; and
obtaining a user intent represented by the target input content, and obtaining target watermark information aligning with the target input content based on the user intent.

4. The method of claim 3, wherein generating the target watermark information based on the user information and/or model information includes one or more of:
processing model information of a target generation model into a first string of data and/or a first set of image elements as the target watermark information;
processing user information associated with the target trigger event into a second string of data and/or a second set of image elements as the target watermark information;
processing user information and time information associated with the target trigger event into a second string of data and/or a second set of image elements as the target watermark information;
processing the model information of the target generation model into the first string data and/or the first set of image elements, processing the user information associated with the target trigger event into the second string data and/or the second set of image elements, and processing the first string data and/or the first set of image elements and the second string data and/or the second set of image elements into the target watermark information; and
processing the model information of the target generation model into the first string data and/or the first set of image elements, processing the user information and the time information associated with the target trigger event into the second string data and/or the second set of image elements, and processing the first string data and/or the first set of image elements and the second string data and/or the second set of image elements into the target watermark information.

5. The method of claim 1, wherein generating the target data based on the target watermark information and the target input content includes one or more of:
identifying an initial user intent represented by the target input content, updating the initial user intent using the target watermark information or its associated data to obtain a target user intent, and generating the target data aligning with the target user intent;
inputting the target watermark information and target input content into a target generation model that aligns with the target trigger event, and embedding at least a portion of the target watermark information or its associated data into the generated target data during the target generation model's execution of a generation operation corresponding to the target input content; and
determining a target position in the initial generated data generated based on the target input content, and inserting at least a portion of the target watermark information or its associated data into a corresponding target position to generate the target data.

6. The method of claim 1, wherein embedding the target watermark information into the target data includes one or more of:
obtaining attribute information of the target data, and embedding the target watermark information or its associated data into the target data using a target embedding strategy based on the attribute information, wherein an amount of target watermark information or its associated data embedded into the target data varies under different embedding strategies;
obtaining usage information of the target data, and embedding a target portion of the target watermark information or its associated data into the target data based on the usage information, wherein the target portion is a portion that aligns with the usage information; and
obtaining authorization information of a target user, and determining whether to embed the target watermark information or its associated data into the target data based on the authorization information.

7. The method of claim 1, further comprising one or both of:
after generating the target data, performing a quality check on the target data; and
after generating the target data, verifying the watermark information embedded in the target data.

8. The method of claim 1, further comprising:
in response to receiving a traceability request for the target data, extracting target watermark information from the target data; and
decrypting the extracted target watermark information and obtaining a traceability result for the target data based on the decryption result.

9. The method of claim 1, wherein the target trigger event is a target text generation request.

10. An electronic device, comprising: a memory storing computer program instructions; and a processor coupled to the memory and configured to execute the computer program instructions and perform:
in response to a target trigger event, obtaining target watermark information;
generating target data based on the target watermark information and target input content by using an AI processing model for data generation, such that the target watermark information is embedded in the target data, wherein
the target watermark information is used to identify a source of the target data, and different trigger events correspond to different embedded watermark information embedded in the target data.

11. The electronic device of claim 10, wherein the target trigger event is generated by one or more of:
the target trigger event is generated in response to monitoring a first input content inputted into a first application;
the target trigger event is generated in response to obtaining a second input content, the second input content being used to call a target generation model of an electronic device;
the target trigger event is generated in response to obtaining a third input content, the third input content being capable of triggering the electronic device to perform an operation of adding watermark information; and
the target trigger event is generated in response to monitoring an operation of sharing a target file.

12. The electronic device of claim 10, wherein obtaining target watermark information includes one or more of:
obtaining source information of the target trigger event, and obtaining target watermark information aligning with the target trigger event based on the source information;
obtaining user information and/or model information associated with the target trigger event, and generating the target watermark information based on the user information and/or model information; and
obtaining a user intent represented by the target input content, and obtaining target watermark information aligning with the target input content based on the user intent.

13. The electronic device of claim 12, wherein generating the target watermark information based on the user information and/or model information includes one or more of:
processing model information of a target generation model into a first string of data and/or a first set of image elements as the target watermark information;
processing user information associated with the target trigger event into a second string of data and/or a second set of image elements as the target watermark information;
processing user information and time information associated with the target trigger event into a second string of data and/or a second set of image elements as the target watermark information;
processing the model information of the target generation model into the first string data and/or the first set of image elements, processing the user information associated with the target trigger event into the second string data and/or the second set of image elements, and processing the first string data and/or the first set of image elements and the second string data and/or the second set of image elements into the target watermark information; and
processing the model information of the target generation model into the first string data and/or the first set of image elements, processing the user information and the time information associated with the target trigger event into the second string data and/or the second set of image elements, and processing the first string data and/or the first set of image elements and the second string data and/or the second set of image elements into the target watermark information.

14. The electronic device of claim 10, wherein generating the target data based on the target watermark information and the target input content includes one or more of:
identifying an initial user intent represented by the target input content, updating the initial user intent using the target watermark information or its associated data to obtain a target user intent, and generating the target data aligning with the target user intent;
inputting the target watermark information and target input content into a target generation model that aligns with the target trigger event, and embedding at least a portion of the target watermark information or its associated data into the generated target data during the target generation model's execution of a generation operation corresponding to the target input content; and
determining a target position in the initial generated data generated based on the target input content, and inserting at least a portion of the target watermark information or its associated data into a corresponding target position to generate the target data.

15. The electronic device of claim 10, wherein embedding the target watermark information into the target data includes one or more of:
obtaining attribute information of the target data, and embedding the target watermark information or its associated data into the target data using a target embedding strategy based on the attribute information, wherein an amount of target watermark information or its associated data embedded into the target data varies under different embedding strategies;
obtaining usage information of the target data, and embedding a target portion of the target watermark information or its associated data into the target data based on the usage information, wherein the target portion is a portion that aligns with the usage information; and
obtaining authorization information of a target user, and determining whether to embed the target watermark information or its associated data into the target data based on the authorization information.

16. The electronic device of claim 10, wherein the processor is further configured to execute the computer program instructions and perform:
after generating the target data, performing a quality check on the target data.

17. The electronic device of claim 16, wherein the processor is further configured to execute the computer program instructions and perform:
after generating the target data, verifying the watermark information embedded in the target data.

18. The electronic device of claim 10, wherein the processor is further configured to execute the computer program instructions and perform:
in response to receiving a traceability request for the target data, extracting target watermark information from the target data; and
decrypting the extracted target watermark information and obtaining a traceability result for the target data based on the decryption result.

19. The electronic device of claim 10, wherein the target trigger event is a target text generation request.

20. A non-transitory computer-readable storage medium storing computer program instructions executable by at least one processor to perform:
in response to a target trigger event, obtaining target watermark information;
generating target data based on the target watermark information and target input content, such that the target watermark information is embedded in the target data, wherein
the target watermark information is used to identify a source of the target data, and different trigger events correspond to different embedded watermark information embedded in the target data.
